(19) United States
(12) Patent Application Publication
(10) Pub. No.: US 2026/0288096 A1
(43) Pub. Date: Sep. 24, 2026

(54) PROVIDING AN INPUT SIGNAL FOR A SIGNAL SINK

(71) Applicant: Siemens Aktiengesellschaft, 80333 München (DE)

(72) Inventors: HEINZ KERPEN, Herzogenaurach (DE); SEBASTIAN SCHWEDE, Nürnberg (DE)

(73) Assignee: Siemens Aktiengesellschaft, 80333 München (DE)

(21) Appl. No.: 19/474,312

(22) PCT Filed: Apr. 5, 2024
(86) PCT No.: PCT/EP2024/059291

§ 371 Date: Oct. 10, 2025

(30) Foreign Application Priority Data
Apr. 14, 2023 (EP) 23167993.7

(51) Int. Cl. G05B 15/02

(52) U.S. Cl. CPC G05B 15/02

(57) ABSTRACT

A method for providing an input signal for a signal sink by using a configuration unit includes receiving with the configuration unit a signal value for the input signal from a signal source and to allowing a user of the configuration unit to define a substitute value for the signal value from the signal source when the signal source does not provide a signal value.

The invention relates to a method and a configuration unit for providing an input signal for a signal sink.

In order to effect open-loop or closed-loop control of a system, for example a drive system, it is usual to process signals. Signal sources that supply these signals include sensors, for example. Signal values of these signals include, for example, values of a temperature, of a pressure, of an electrical current strength, of an electrical voltage or of a rotational speed. If a signal source fails or the connection to a signal source is disrupted or interrupted, the signal of the signal source must be replaced by a substitute value. Substitute values are usually set automatically by the system.

The object of the invention is to specify a method and a configuration unit for providing an input signal for a signal sink, said method and configuration unit being improved with regard in particular to the definition of substitute values.

US 2018/172370 A1 discloses a method for controlling the opening of a valve in an HVAC system. The method comprises the control of the opening of a six-port valve in accordance with a standard control mode as a function of a standard sensor signal. A standard control mode is selected from a first standard control mode and a second standard control mode. During the control of the valve in the selected standard control mode, it is ascertained whether the sensor signal is erroneous. If the signal is erroneous, a switch is effected in a manner dependent on the selected standard control mode, such that the opening of the valve is controlled in accordance with a first fallback control mode or an alternative second fallback control mode, in which the opening of the valve is controlled independently of the erroneous sensor signal.

DE 11 2015 000 941 T5 discloses a vehicle-side device-control unit having at least two redundant operating-state detection units. Under normal circumstances, the control unit executes an actuator drive control on the basis of an operating-state detection signal from one of the operating-state detection units. If an anomaly is detected in the signal transmission state, data state or operating state by one of the at least two operating-state detection units, the control unit executes an actuator drive control on the basis of an operating-state detection signal from another of the at least two operating-state detection units, in which no anomaly is present.

DE 10 2018 122 371 A1 discloses an extended modular controller comprising a multiplicity of configurable communication ports and a control logic level that can be used to control the equipment of a process plant. The communication ports comprise a first set of communication ports and a second set of communication ports, which can be used to communicate with one or more nodes of a distributed control system of the process plant. The extended modular controller also includes a software level which accepts port configuration parameters that define one or more port communication rules for the first set of communication ports and for the second set of communication ports. The one or more port communication rules have the effect that the software level selectively permits or restricts the forwarding of incoming messages, the incoming messages being received at the first or second set of communication ports.

The object is inventively achieved by a method having the features in claim 1, a configuration unit having the features in claim 8 and a computer program product having the features in claim 13.

Advantageous embodiments of the invention are the subject matter of the subclaims.

In the inventive method, an input signal for a signal sink is provided by means of a configuration unit, the configuration unit being designed
to receive a signal value for the input signal from a signal source, and
to enable a user of the configuration unit to define a substitute value for the signal value of the signal source if the signal source does not supply a signal value,

The configuration unit therefore enables a user personally to define a substitute value for a signal value of a signal source if the signal source does not supply a signal value, for example because the signal source fails or the connection to the signal source is disrupted or interrupted. It is thereby possible for a user-specific substitute value to be defined or for the substitute value to be adapted by the user as required, as opposed to a substitute value being automatically set by the system, for example.

In an embodiment of the inventive method, the configuration unit is designed to ascertain signal sources that are adapted to the type of the input signal, and to enable the user to select the signal source from these signal sources.

The above cited embodiment of the inventive method enables the user of the configuration unit personally to ascertain the signal source. To this end, the configuration unit ascertains signal sources which are adapted to the type of the input signal, and from which the user can select a signal source. For example, in order to allow this selection, the configuration unit is designed to ascertain signal sources whose signal values correspond to a physical variable that is adapted to the input signal. If the physical variable of the input signal is for example a temperature, the configuration unit then ascertains as signal sources that can be selected by the user, for example, signal sources whose signal values are temperature values. By adapting the selectable signal sources to the input signal, the selection of a signal source is made easier for the user and the danger of erroneous selection of the signal source by the user is reduced.

In the inventive method, the configuration unit is designed to enable the user, for the purpose of defining the substitute value, to select as a substitute for the signal source a substitute signal source whose signal value is used as a substitute value.

According to the above cited feature of the inventive method, the configuration unit offers the user a selection of substitute signal sources for the purpose of defining the substitute value. By selecting one of these substitute signal sources, the signal value supplied by this substitute signal source is defined as the substitute value.

In a further embodiment of the inventive method, the configuration unit is designed to ascertain a preselection of substitute signal sources that is adapted to the type of the input signal, and to enable a user of the configuration unit to restrict the selection of the substitute signal source to this preselection.

According to the above cited embodiment of the inventive method, the selection of the substitute signal sources can be restricted by the user to a preselection ascertained by the configuration unit. The preselection of the substitute signal sources is adapted in this case to the type of the input signal of the signal sink. For example, the preselection restricts the selectable substitute signal sources to substitute signal sources whose signal values correspond to a physical variable which is adapted to the input signal. If the physical variable of the input signal is a temperature, for example, the preselection restricts the selectable substitute signal sources to substitute signal sources whose signal values are temperature values. Such a preselection of substitute signal sources makes it easier for the user to select a substitute signal source, and reduces the danger of erroneous selection of the substitute signal source by the user. The provision of a preselection of substitute signal sources by the configuration unit can be activated and deactivated by the user in this case, so that the user can decide personally whether to take advantage of the preselection.

In a further embodiment of the inventive method, the configuration unit is designed to enable a user of the configuration unit to define a fixed value as a substitute value.

According to the above cited embodiment of the inventive method, the configuration unit enables a user to define a fixed value as a substitute value for the signal value. Unlike a substitute value that is supplied by a substitute signal source, the fixed value is a numerical value which the user personally can enter or select from a selection menu that is offered by the configuration unit.

In a further embodiment of the inventive method, the configuration unit is designed to enable a user of the configuration unit to define a fixed value as a substitute value for the signal value even if the signal source supplies a signal value.

According to the above cited embodiment of the inventive method, the configuration unit enables a user to define a fixed value as a substitute for a signal source irrespective of whether the signal source supplies a signal value. In this case, the fixed value therefore replaces the signal source completely.

In a further embodiment of the inventive method, the configuration unit is designed to send the current input signal and all associated signal interconnection information in a single data packet to a system that is controlled using the signal sink, for example an electrical drive system.

The signal interconnection information comprises in particular the source of the input signal, meaning that it contains information which indicates whether the source of the input signal is the signal source, a substitute signal source or a fixed value. As a result of transmitting the input signal and all associated signal interconnection information in a single data packet, the consistency of the transmitted information is ensured, meaning that inconsistencies that can occur when transmitting the information in a plurality of data packets are avoided.

In a further embodiment of the inventive method, the signal sink is designed to display the current input signal and all associated signal interconnection information.

Therefore all of the information relating to the input signal can advantageously be displayed to the user directly at the signal sink.

An inventive configuration unit for providing an input signal for a signal sink is designed
to receive a signal value for the input signal from a signal source, and
to enable a user of the configuration unit to define a substitute value for the signal value of the signal source if the signal source does not supply a signal value.

According to an embodiment of the invention, the configuration unit is designed to ascertain signal sources that are adapted to the type of the input signal, and to enable the user to select the signal source from these signal sources.

Furthermore, the configuration unit is designed to enable the user, for the purpose of defining the substitute value, to select as a substitute for the signal source a substitute signal source whose signal value is used as a substitute value.

According to a further embodiment of the invention, the configuration unit is designed to ascertain a preselection of substitute signal sources that is adapted to the type of the input signal, and to enable a user of the configuration unit to restrict the selection of the substitute signal source to this preselection.

According to a further embodiment of the invention, the configuration unit is designed to enable a user of the configuration unit to define a fixed value as a substitute value.

According to a further embodiment of the invention, the configuration unit is designed to enable a user of the configuration unit to define a fixed value as a substitute value for the signal value even if the signal source supplies a signal value.

According to a further embodiment of the invention, the configuration unit is designed to send the current input signal and all associated signal interconnection information in a single data packet to a system that is controlled using the signal sink, for example an electrical drive system.

A configuration unit according to the invention can additionally have in particular a web server which can be contacted by a user, for example via a web client, and via which the configuration unit can be operated by the user, for example via a graphical user interface.

A computer program product according to the invention comprises instructions which, when said instructions are executed by a computer, cause this computer to execute the inventive method as a configuration unit.

A configuration unit according to the invention and a computer program product according to the invention enable the execution of the inventive method. Therefore the advantages of a configuration unit according to the invention and a computer program product according to the invention correspond to the above cited advantages of the inventive method.

The properties, features and advantages described above in respect of this invention, and the manner in which they are achieved, become clearer and easier to understand in the context of the following description of exemplary embodiments that are explained in greater detail with reference to the drawings, in which:

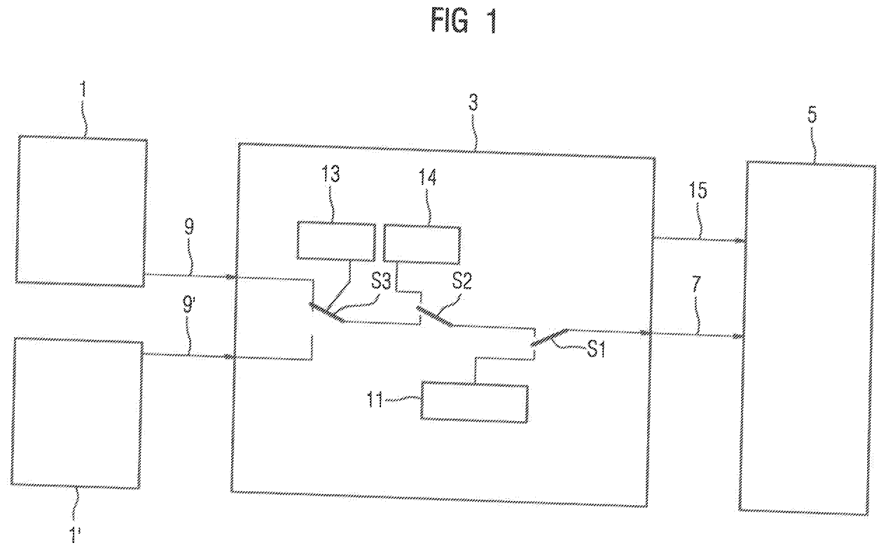

FIG. 1 shows a block diagram of a signal source, a configuration unit and a signal sink, and

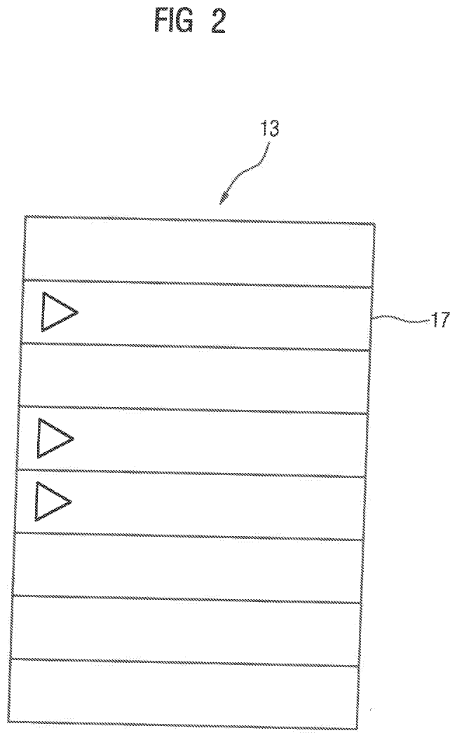

FIG. 2 shows a selection menu for selecting a signal source.

Parts which correspond to each other are denoted by the same reference characters in the figures.

FIG. 1 shows a block diagram of a signal source 1, a configuration unit 3 according to an exemplary embodiment of the invention, and a signal sink 5. The signal source 1, the configuration unit 3 and the signal sink 5 are components of a controller for an electrical drive system, for example.

The signal source 1 is a sensor, for example, which is designed to detect the value of a physical variable, for example the value of a temperature, of a pressure, of an electrical current, of an electrical voltage or of a rotational speed.

The configuration unit 3 is designed to ascertain signal sources 1, 1′ that are adapted to the type of the input signal 7, and to enable a user of the configuration unit 3 to select the signal source 1 from these signal sources 1, 1′. The option allowing the selection of the signal source 1 is symbolized in FIG. 1 by a circuit symbol S3. For selection of the signal source 1, the configuration unit 3 provides the user with a selection menu 13, for example, from which the user can select the signal source 1.

FIG. 2 shows an exemplary selection menu 13. The selection menu 13 has a plurality of selection fields 17 arranged one above the other. Assigned to each selection field 17 is a signal source 1, 1′ which can be selected via the respective selection field 17, for example by means of a mouse click.

The configuration unit 3 is further designed to ascertain a preselection of signal sources 1, 1′ that is adapted to the type of the input signal 7, and to enable a user of the configuration unit 3 to restrict the selection of the signal source 1 to this preselection. In FIG. 2, those selection fields 17 to which signal sources 1, 1′ of such a preselection are assigned have an arrow symbol that identifies the preselected signal sources 1, 1′. The user can decide, for example via a further selection field, whether the selection of the signal source 1 is restricted to the preselected signal sources 1, 1′.

The configuration unit 3 provides an input signal 7 for the signal sink 5. For this purpose, the configuration unit 3 is designed to receive a signal value 9 for the input signal 7 from the signal source 1. Furthermore, the configuration unit 3 enables a user of the configuration unit 3 to define a substitute value for the signal value 9 of the signal source 1.

For the purpose of defining the substitute value, the configuration unit 3 provides the user with two possibilities. Firstly, it enables the user to define a fixed value for the input signal 7. The fixed value is a number that can be defined by the user. The option to define a fixed value for the input signal 7 is symbolized in FIG. 1 by a circuit symbol S1. For the purpose of defining the fixed value, the configuration unit 3 provides the user with an input field 11, for example, into which the user can enter the fixed value.

Secondly, the configuration unit 3 enables the user to define a substitute value which is automatically used instead of the signal value 9 by the configuration unit 3 if no fixed value for the input signal 7 is defined and the signal source 1 does not supply a signal value 9, for example because the signal source 1 falls or the connection to the signal source 1 is disrupted or interrupted. Alternatively or additionally, for the purpose of defining the substitute value, the configuration unit 3 enables the user to select as a substitute for the signal source 1 a substitute signal source whose signal value is used as a substitute value if no fixed value for the input signal 7 is defined. The option to use such a substitute value is symbolized in FIG. 1 by a circuit symbol S2. For the purpose of defining the substitute value, the configuration unit 3 provides the user with a control element 14, for example. For the purpose of defining a substitute value that is automatically to be used instead of the signal value 9 by the configuration unit 3, the control element 14 has an input field, for example, into which the user can enter the substitute value. For the selection of a substitute signal source, the control element has a selection menu, for example, from which the user can select the substitute signal source and which is designed in a similar manner to the selection menu 13. As for the selection of the signal source 1, the configuration unit 3 can additionally be designed to ascertain a preselection of substitute signal sources that is adapted to the type of the input signal 7, and to enable a user of the configuration unit 3 to restrict the selection of the substitute signal source to this preselection. The user can decide, for example via a further selection field, whether the selection of the substitute signal source is restricted to the preselected substitute signal sources.

The input signal 7 and all associated signal interconnection information 15 are transmitted to the signal sink 5 from the configuration unit 3. The signal interconnection information 15 comprises in particular the source of the input signal 7, meaning that it contains the information which indicates whether the source of the input signal 7 is the signal source 1, a substitute value, a substitute signal source or a fixed value. The input signal 7 and the signal interconnection information 15 are displayed at the signal sink 5.

Although the invention is illustrated and described in detail with reference to preferred exemplary embodiments, the invention is not restricted by the disclosed examples and other variations may be derived therefrom without departing from the scope of protection.

Independent of the grammatical term usage, individuals with male, female or other gender identities are included within the term.

1-13. (canceled)

14. A method for providing with a configuration unit an input signal for a signal sink, the method comprising:
with the configuration unit, receiving a signal value for the input signal from a signal source,
enabling a user of the configuration unit, if the signal source fails to supply a signal value, to define a substitute value for the signal value by selecting a substitute signal source whose signal value is used as the substitute value, and
with the configuration unit, sending a current input signal and associated signal interconnection information, including information about the signal source, in a single data packet to a system that is controlled using the signal sink in order to avoid inconsistencies.

15. The method of claim 14, wherein the system that is controlled using the signal sink is an electronic drive system.

16. The method of claim 14, further comprising ascertaining with the configuration unit signal sources that are adapted to the type of the input signal, and enabling the user to select the signal source from the ascertained signal sources,

17. The method of claim 14, further comprising ascertaining with the configuration unit a preselection of substitute signal sources adapted to the type of the input signal, and enabling the user to restrict selection of the substitute signal source to this preselection.

18. The method of claim 14, further comprising enabling with the configuration unit the user to define a fixed value as the substitute value.

19. The method of claim 18, further comprising enabling with the configuration unit the user to define a fixed value as the substitute value even when the signal source supplies the signal value.

20. The method of claim 14, further comprising displaying with the signal sink the current input signal and the associated signal interconnection information, including the information about the signal source.

21. A configuration unit for providing an input signal for a signal sink, wherein the configuration unit is designed
to receive a signal value for the input signal from a signal source,
to enable a user of the configuration unit, if the signal source fails to supply a signal value, to define a substitute value for the signal value by selecting a substitute signal source whose signal value is used as the substitute value, and
to send a current input signal and associated signal interconnection information, including information about the signal source, in a single data packet to a system that is controlled using the signal sink in order to avoid inconsistencies.

22. The configuration unit of claim 21, wherein the system that is controlled using the signal sink is an electronic drive system.

23. The configuration unit of claim 21, designed to ascertain signal sources that are adapted to the type of the input signal, and to enable the user to select the signal source from the ascertained signal sources.

24. The configuration unit of claim 21, designed to ascertain a preselection of substitute signal sources adapted to the type of the input signal, and to enable the user to restrict selection of the substitute signal source to this preselection.

25. The configuration unit of claim 21, designed to enable the user to define a fixed value as the substitute value.

26. A computer program product embodied on a non-transitory storage medium and comprising program instructions which, when read into a memory of a computer and executed by a processor of the computer, cause the computer to operate as a configuration unit and execute the method of claim 14.
